(19) United States
(12) Patent Application Publication
(10) Pub. No.: US 2007/0148290 A1
(43) Pub. Date: Jun. 28, 2007

(54) PORTION CAPSULE

(75) Inventors: Rudiger Ternite, Hamburg (DE); Klaus-Dieter Mund, Hamburg (DE); Hartwig Meyer-Ruhstrat, Stelle (DE); Ingo Lantz, Hamburg (DE)

Correspondence Address: HOVEY WILLIAMS LLP, 2405 GRAND BLVD., SUITE 400, KANSAS CITY, MO, 64108, US

(73) Assignee: TCHIBO GMBH, Hamburg (DE)

(21) Appl. No.: 11/565,301

(22) Filed: Nov. 30, 2006

(30) Foreign Application Priority Data
Dec. 2, 2005 (DE) 10 2005 058 336.9

(51) Int. Cl. A23G 3/00

(52) U.S. Cl. 426/90

(57) ABSTRACT

A portion capsule, which is suitable in particular for brewing coffee, has a capsule cover and a capsule base and is closed on all sides in the state in which it is supplied. It contains a particulate beverage substance which can be extracted by water. A screening device is arranged between the beverage substance and the capsule base. The screening device is spaced apart from the capsule base, in the central region of the latter, by means of an annular structure which defines an outer region and an inner region in the interspace between the screening device and capsule base. The outer region is connected to the inner region via through-openings.

### CROSS REFERENCE TO RELATED APPLICATION

This Application claims priority of German Application Serial No. DE 10 2005 058 336.9, filed Dec. 2, 2005, which is hereby incorporated by reference herein.

### BACKGROUND OF THE INVENTION

1. Field of the Invention

The invention relates to a portion capsule (cartridge) which is suitable in particular for brewing individual portions of coffee (one cup or two cups of coffee) in a coffee machine intended for using portion capsules.

2. Discussion of Prior Art

EP 1 344 722 A1 describes a portion capsule which comprises a capsule cover and a capsule base, is closed on all sides in the state in which it is supplied and contains a particulate coffee substance which can be extracted by means of water. In this case, a distributor device is arranged between the capsule cover and the coffee substance and a collecting device is arranged between the coffee substance and the capsule base. The distributor device and the collecting device each have a number of openings and embossments for forming liquid channels. This portion capsule is used in a specific coffee machine, the capsule cover and the capsule base being perforated when the portion capsule is inserted into the machine or during the brewing operation. It is thus the case that hot water passes onto the distributor device through an opening in the capsule cover and is essentially uniformly distributed by this device, so that the coffee substance in the portion capsule can be largely uniformly extracted. The completed beverage is directed by the collecting device to an opening in the capsule base. In this case it flows, in the first instance, through the openings of the collecting device, which have a screening or filtering function, and can then flow through a cavity between the collecting device and the capsule base, this cavity being formed between the embossments of the collating device, to the opening in the capsule base. There, the beverage passes out of the portion capsule and can be intercepted by a receptacle (e.g. a cup).

In addition to the above mentioned functions as a directing device, as a screen or filter and as a spacer, the collecting device of the already known portion capsule also has the additional function of ensuring the formation of crema (foam, froth) in the coffee beverage should this be desired. This is the case, in particular, for cafe crema and espresso, while, in Germany for example, normal filter coffee should not have any crema. In the case of the already known portion capsule, however, it is not possible to control to a satisfactory extent the formation of crema in conjunction with the other functions of the collecting device.

### SUMMARY OF THE INVENTION

The object of the invention is to provide a portion capsule which comprises a beverage substance which can be extracted by means of water and in the case of which the formation of crema can be better controlled than in the case of the already known portion capsule.

This object is achieved by a portion capsule having the features of claim 1. Advantageous configurations of the invention can be gathered from the subclaims.

The portion capsule according to the invention has a capsule cover and a capsule base and is closed on all sides in the state in which it is supplied. It contains a particulate beverage substance, preferably ground coffee, which can be extracted by means of water. A screening device is arranged between the beverage substance and the capsule base and performs a screening or filtering function.

The screening device is spaced apart from the capsule base, in the central region of the latter, by means of an annular structure. The annular structure defines an outer region (located outside the annular structure) and an inner region (located within the annular structure) in the interspace between the screening device and capsule base. The term “annular structure” is to be understood here in a more general sense than being limited to a ring which appears to be circular in plan view; thus, the annular structure maybe, for example quadrilateral or also irregular in plan view and, in addition, need not necessarily be closed in the circumferential direction. The outer region and the inner region of the annular structure are connected via through-openings. The height of the annular structure is preferably less than 20% of the height of the portion capsule, e.g. less than 10%.

The annular structure of the portion capsule according to the invention helps to form an interspace between the screening device and the capsule base. This interspace accommodates extracted beverage which has passed through the screening device during the brewing operation and can leave the portion capsule through an opening made in the central region of the capsule base. It has to flow through the through-openings here. The formation of crema can be controlled via the configuration of the through-openings. This is completely independent of the design of the screening device. In the case of the portion capsule according to the invention, the devices for the screening or filtering function and for the formation of crema are thus separate from one another, which increases the design possibilities.

In the case of preferred embodiments, the beverage substance has ground coffee. It is possible here for the through-openings to be relatively small and to be intended for forming a crema. This is because, when coffee flows through small openings, in particular at a relatively high pressure (e.g. 7 bar to 13 bar or 9 bar to 18 bar, as is customary for cafe crema and espresso, respectively), turbulence results in the inclusion of air, this leading to the formation of crema.

If, in contrast, the through-openings are relatively large, the flow, in particular at lower pressures (e.g. 1 bar to 7 bar for filter coffee) is largely laminar, so that only a small amount of crema is produced, if any at all. A person skilled in the art can easily ascertain from tests the optimum size and shape of through-openings for each individual case.

In the case of preferred embodiments of the invention, the screening device has a supporting structure. The annular structure is preferably formed integrally with the supporting structure, e.g. as an injection moulding. The supporting structure may have one or more spacers which butt against the capsule base outside the central region of the latter, so that, in the central region, these spacers together with the annular structure ensure the desired interspace between the screening device and capsule base. It is not necessary here for the interspace to extend over the entire surface area of the capsule base. It is preferable for the spacer or spacers to be designed as a protrusion, e.g. as a peripheral annular bead projecting in the direction of the capsule base or as a number of punctiform protrusions.

The supporting structure may be provided with at least one cutout which is covered over by a planar textile fabric, e.g. a woven fabric or a nonwoven. More details on such embodiments can be found in German patent application 10 2005 016 297. The planar textile fabric here can be connected to the supporting structure, for example, by adhesive bonding, welding, stamping or embedding.

The screening device may also have a perforated screen which is preferably formed integrally with the supporting structure, e.g. as injection moulding. Since modem injection-moulding techniques can even form holes which are fine enough to be used, for example, for a coffee filter, such an integral design may have cost-related advantages. It is also conceivable, however, for cutouts in a supporting structure to be coated with conventional filter paper.

In the case of preferred embodiments of the invention, in its central region, the supporting structure has a protuberance which is directed away from the annular structure and is intended for accommodating a spike on a coffee machine coordinated with the portion capsule. Portion capsules with such a protuberance are intended for coffee machines in which the portion capsule is perforated on the capsule base with the aid of a spike. The intention is for the spike just to penetrate the capsule base, but not to damage the screening device, for which reason the screening device is set back into the interior of the portion capsule at the point where the spike penetrates, that is to say in the region of the protuberance.

It is also advantageous if the supporting structure has a reinforcing rim along its periphery, e.g. a rim which projects from a disc-like structure. A large number of very different configurations are basically conceivable for the supporting structure.

Furthermore, the portion capsule according to the invention may have a distributor device which is arranged between the capsule cover and the beverage substance. The distributor device may be designed, for example, as a (planar) plate with through-passages or else as a curved structure with through-passages, it being possible for the through-passages to be configured, for example, as radially running slits and/or as holes. The distributor device preferably does not have any channel-like embossments. As a result of the distributor device, water which is introduced at the capsule cover in order to extract the beverage is distributed largely uniformly in the beverage substance.

In the case of a preferred embodiment, it is also the case that, in its central region, the distributor device has a protuberance, which in this case is directed away from the capsule cover and is intended for accommodating a spike on a coffee machine coordinated with the portion capsule, the water being introduced into the portion capsule via this spike. In a manner similar to the previously explained protuberance of the screening device, it is also the case that the protuberance of the distributor device is not damaged when the spike penetrates into the portion capsule.

The capsule base may have a predetermined weakened location in its central region. Capsule base is generally to be understood as that side of the portion capsule from which the beverage passes out of the portion capsule, that is to say irrespective of whether the capsule base is located, for example, at the top or bottom when the portion capsule has been positioned in a coffee machine. The predetermined weakened location makes it easier to pierce the capsule base in the coffee machine. The predetermined weakened location preferably has apiece of sheet material which is weaker than the capsule base in the vicinity of the piece of sheet material.

The beverage substance may also have substances other than ground coffee, e.g., tea, chocolate (in which case, once again, the possibilities provided by the invention for controlling the formation of crema are beneficial), instant soup, milk powder, liquid milk (as an addition), etc. or mixtures of such substances, including with ground coffee.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 shows a longitudinal section through an embodiment of a portion capsule according to the invention which is intended for brewing cafe crema,

FIG. 2 shows a longitudinal section through the screening device of the portion capsule from FIG. 1,

FIG. 3 shows a three-dimensional view from above of the supporting structure of the screening device from FIG. 2,

FIG. 4 shows a three-dimensional view from beneath of the supporting structure of the screening device from FIG. 2,

FIG. 5 shows a three-dimensional view from beneath of a variant of the distributor device of the portion capsule from FIG. 1,

FIG. 6 shows a longitudinal section through a second embodiment of a screening device,

FIG. 7 shows a three-dimensional view from beneath of a variant of the screening device according to FIG. 6,

FIG. 8 shows an enlargement of a detail from FIG. 7, and

FIG. 9 shows a longitudinal section through a further embodiment of a portion capsule according to the invention, this one being intended for brewing filter coffee.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

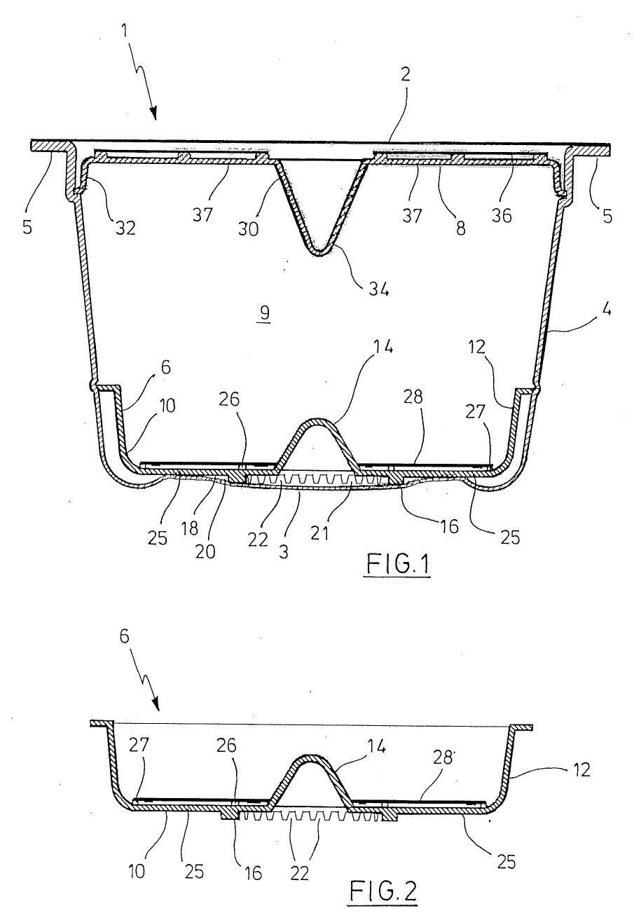

FIG. 1 illustrates an embodiment of a portion capsule 1 in longitudinal section. The portion capsule 1 has a capsule cover 2, a capsule base 3 and an encircling wall 4 which, in the exemplary embodiment, is formed integrally with the capsule base 3. Projecting from the top end of the wall 4 is an annular flange 5 on which, in the exemplary embodiment, the capsule cover 2 is sealed. The portion capsule 1 is thus closed on all sides in the state in which it is supplied.

In the interior of the portion capsule 1, a screening device 6 is located above the capsule base 3 and a distributor device 8 is located beneath the capsule cover 2. The space between the screening device 6 and the distributor device 8 is filled with a coffee powder 9, to be precise, in the exemplary embodiment according to FIG. 1, with a coffee powder suitable for brewing cafe crema.

The terms “top/upwards/upwardly” and “bottom/downwards/downwardly” here relate to the illustration in the figures, irrespective of the direction in which a portion capsule is positioned for use in a coffee machine. It is also possible here, in principle, for the base to be located at the top and the cover to be located at the bottom. In the terminology selected here, the brewing water is directed into the portion capsule at the capsule cover, while the completed beverage passes out of the capsule base. More details on how this can take place are explained herein below.

In the exemplary embodiment, the capsule base 3 and the wall 4 of the portion capsule 1 are produced from a plastic, e.g. as an injection moulding or as a thermoformed component. It is also possible here to use multi-layered materials as are known from foodstuff-packaging technology. In the exemplary embodiment, the capsule cover 2 comprises a composite sheet material made up of aluminium and plastics.

FIG. 2 shows the screening device 6, once again in longitudinal section. The screening device 6 contains a supporting structure 10 with an upright reinforcing rim 12 which, at its top end, projects outwards in a flange-like manner. A conical protuberance 14 which is oriented upwards is provided in the central region of the supporting structure 10. An annular structure 16 is located on the underside. In the exemplary embodiment, the supporting structure 10 and the annular structure 16 are produced integrally as an injection moulding from a plastic which is suitable for foodstuffs, e.g. polypropylene.

FIG. 1 illustrates how the annular structure 16 spaces the screening device 6 apart from the capsule base 3, as a result of which an interspace 18 is formed between the screening device 6 and the capsule base 3. The interspace 18 contains two sub-regions, namely an outer region 20 outside the annular structure 16 and an inner region 21 within the annular structure 16. The outer region 20 and the inner region 21 are connected via through-openings 22 which, in the exemplary embodiment, are designed as interspaces between downwardly oriented prongs of the annular structure 16. In the case of an alternative configuration, it is also conceivable for the through-openings to be provided as bores which are bounded all the way round by material of the annular structure.

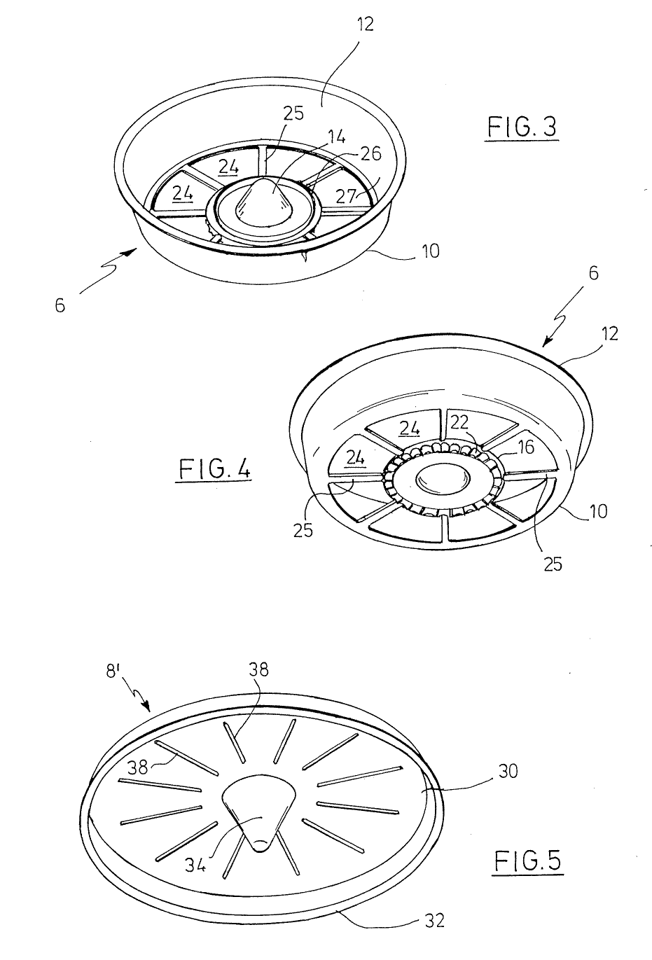

FIGS. 3 and 4 show the supporting structure 10 in three-dimensional views from above and from beneath, the configuration of the annular structure 16 thus being particularly clear. A number of large-surface-area cutouts 24 separated from one another by radial ribs 25 are provided on the supporting structure 10. In FIGS. 1 and 2, the section plane runs through two ribs 25; the through-openings 22 which are shown in FIGS. 1 and 2 are located outside the section plane, but are nevertheless illustrated for the sake of clarity.

A planar textile fabric 28 which serves as a filter is fitted above the cutouts 24, on two encircling protrusions 26 and 27. The planar textile fabric 28 is, for example, a woven fabric or a nonwoven. Mixed forms are likewise conceivable, e.g. multi-layered structures in which, for example, a nonwoven layer is applied to a woven-fabric layer. It is also possible for the planar textile fabric to be configured, for example, as a knitted or crocheted fabric.

Possible materials for the planar textile fabric are filaments and/or fibres made of plastics and/or natural materials, but also metal. Examples of suitable plastics are polyolefins (in particular polypropylene and polyethylene) and polyamide. The suitable natural materials include, in particular, cellulose, but it is also possible to use, for example, regenerated celluloses (e.g. viscose). As far as the metals are concerned, high-grade steel is particularly suitable. It is also conceivable to use mixtures of different materials, also mixtures of plastics and natural materials or those with metal filaments.

The planar textile fabric 28 preferably has pores of a size ranging from 10 m to 500 m. Preferred ranges are from 10 m to 200 m or from 30 m to 150 m. If use is made of filaments, particularly preferred filament thicknesses range from 10 m to 200 m or from 30 m to 150 m. The filaments may also be configured as double or multiple filaments (doubled/folded or twisted).

In the exemplary embodiment, the planar textile fabric 28 is configured in one piece as an annular, planar structure and is welded to the encircling protrusions 26 and 27. Adhesive connections or punctiform connections (in particular if the planar textile fabric butts right up against the supporting structure) are likewise conceivable. Instead of being connected by welding or adhesive bonding, it is also possible for the planar textile fabric to be connected to the supporting structure, for example, by stamping, in all cases both from the top side and from the underside of the supporting structure. It is further conceivable for the planar textile fabric to be embedded in the respective supporting structure by injection moulding.

The distributor device 8 is designed in a manner similar to the screening device 6, but does not contain any annular structure. A supporting structure 30 with a reinforcing rim 32 is provided with a downwardly oriented protuberance 34 in its central region. Cutouts (not illustrated in FIG. 1) are covered over by a planar textile fabric 36. The cutouts are separated from one another by radial ribs 37.

FIG. 5 shows a variant 8′ of the distributor device, parts which correspond to one another being provided with the same designations as in FIG. 1. Instead of the cutouts covered by a planar textile fabric, however, narrow radial slits 38 are used here. Other types or arrangements of through-passages in the distributor device are likewise conceivable, e.g. a number of, for example, round holes arranged along concentric lines.

The portion capsule 1 is used in a coffee machine which is designed specifically for using portion capsules. In an example of such a coffee machine, the portion capsule 1 is positioned in a separate capsule holder, which is then inserted into the coffee machine and locked. In this case, a spike (piercing means) penetrates through the central region of the capsule cover 2 into the protuberance 34 without damaging the distributor device 8. A spike (piercing means) is likewise located beneath the capsule base 3, but, in the example, rather than penetrating all the way through the capsule base at this stage, only makes an incipient cut therein. Water under pressure is then directed through the opening in the capsule cover 2 and distributed largely uniformly by the distributor device 8, so that the water can extract the coffee powder 9 located in the portion capsule 1. The pressure in the portion capsule 1 increases here, so that the capsule base 3 bulges outwards to some extent and the spike located beneath the capsule base penetrates all the way through. This spike is configured as a hollow spike and is accommodated in the protuberance 14 without damaging the screening device 6.

Extracted beverage passes through the planar textile fabric 28 of the screening device 6, which acts as a filter, into the outer region 20 of the interspace 18 and, from there, passes through the through-openings 22 into the inner region 21 and, through the hollow spike, outwards, e.g. into a cup set down beneath the capsule holder.

In this example, the coffee powder 9 is intended for brewing cafe crema and, in the case of the brewing operation described, a pressure ranging from, for example, approximately 7 bar to 13 bar is built up in the portion capsule 1 via the coffee machine. Since the through-openings 22 are relatively small, high flow speeds occur in the region of the through-openings 22, and this results in turbulence and the formation of foam, as is desirable for cafe crema. By virtue of the design of the screening device 6, the filtering-device and crema-forming functions are thus assigned to different regions, namely to the planar textile fabric 28 and the annular structure 16 with the through-openings 22, respectively. It is thus possible, by way of the configuration of these regions, to optimize the two functions independently of one another.

Espresso can be brewed in a similar manner, in this case the coffee powder being ground from coffee beans which are customarily used for espresso. Furthermore, the pressure used for brewing purposes is usually higher, e.g. in the range from 9 bar to 18 bar. The formation of crema is also desirable for espresso.

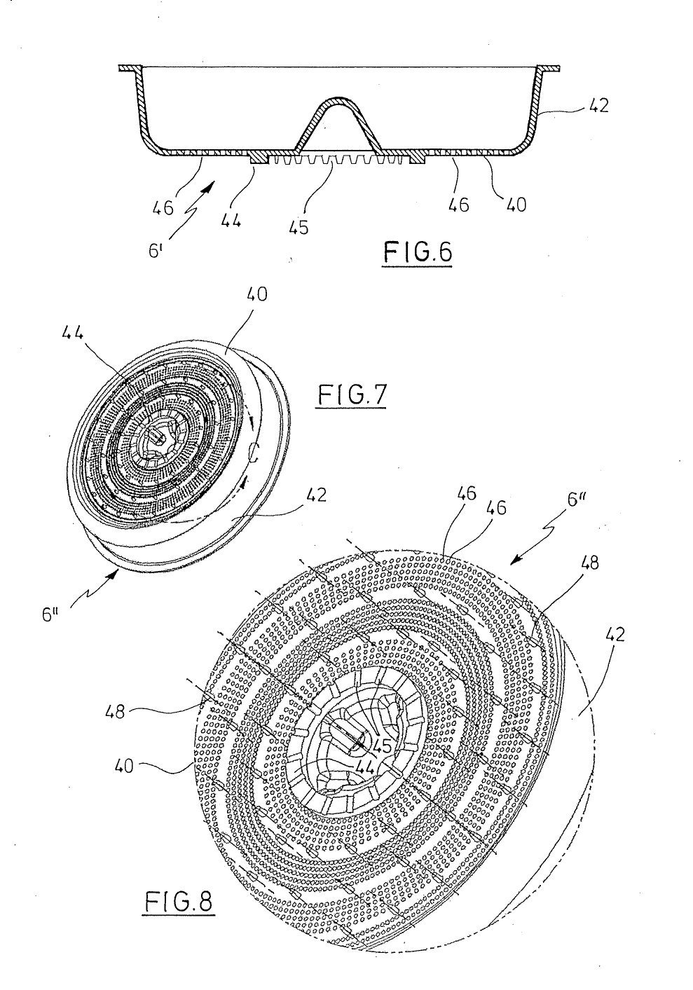

FIG. 6 shows a longitudinal section through a further embodiment of a screening device, in this case designated 6′. The screening device 6′, once again, has a supporting structure 40, with a reinforcing rim 42 and, on its underside, an annular structure 44 with through-openings 45. In contrast to the screening device 6, however, the filtering function, rather than being achieved by means of a planar textile fabric 28, is performed by a multiplicity of holes 46 which are provided in the supporting structure 40. In the exemplary embodiment, the screening device 6′ or the supporting structure 40 is produced integrally with the annular structure 44 as an injection moulding.

FIGS. 7 and 8 show a variant of the screening device from FIG. 6, in this case designated 6″. Parts which correspond to one another are provided with the same designations as in FIG. 6. In the case of the embodiment according to FIGS. 7 and 8, however, the holes 46 are arranged in annular zones, between which downwardly projecting protrusions 48 are located. In the enlarged detail according to FIG. 8, the respective axes for the individual protrusions 48 are depicted as dashed lines. The protrusions 48 ensure a uniform spacing between the capsule base and the screening device 6″, so that a well-defined outer region of the interspace is formed between the screening device 6″ and the capsule base and the extracted beverage can flow through the holes 46 without obstruction. In the exemplary embodiment, the screening device 6″, once again, is produced integrally with the annular structure 44 as an injection moulding using a plastic which is suitable for foodstuffs.

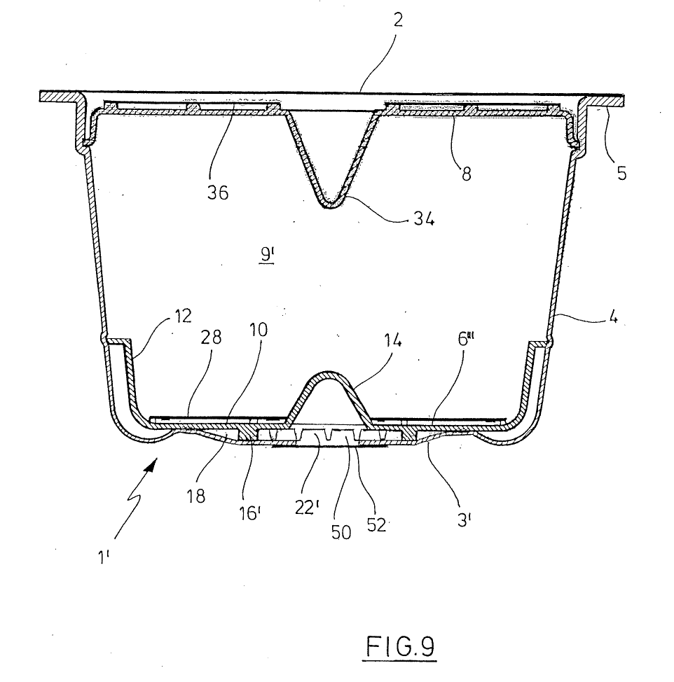

FIG. 9 illustrates a longitudinal section through a further embodiment of a portion capsule, in this case designated 1′. The portion capsule 1′ is constructed in a manner similar to the portion capsule 1 from FIG. 1, for which reason parts which correspond to one another are provided with the same designations.

In the case of the portion capsule 1′, however, the annular structure 16′ formed on the underside of the screening device 6″is higher than the annular structure 16, and wider through-openings 22′ are provided. The through-openings 22′ thus have a larger through-passage cross section than the through-openings 22 from the embodiment according to FIG. 1.

Furthermore, in its central region, the capsule base 3′ has an opening 50 which is closed by a piece of sheet material 52 made of, for example, aluminium foil which is adhesively attached from beneath. As an alternative, it would also be possible for the piece of sheet material to be placed in position from above. The piece of sheet material 52 forms a predetermined weakened location since it can be penetrated more easily, e.g. by means of a spike, than the rest of the material of the capsule base 3′.

The portion capsule 1′ is filled with a coffee powder 9′ which is suitable for brewing filter coffee. If the portion capsule 1′ is inserted into a coffee machine of the type which has been explained in conjunction with the exemplary embodiment according to FIG. 1, the bottom spike pierces the piece of sheet material 52 when the capsule holder is being locked. For the purpose of brewing filter coffee, use is made of a relatively low water pressure, e.g. 1 bar to 7 bar. Once the extracted coffee has passed through the planar textile fabric 28, serving as filter, of the screening device 6″′, it passes into the interspace 18 and, through the large through-openings 22′ to the perforated opening in the piece of sheet material 52 and the penetrated spike, which serves as an outlet. The relatively low pressure and the relatively large through-openings 22′ mean that there is no formation of crema. The filter coffee, once brewed, thus passes out of the coffee machine, in practice, without crema, as is desirable, for example, in Germany.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A portion capsule comprising:
a capsule cover and a capsule base,
said portion capsule being closed on all sides and containing a particulate beverage substance which can be extracted by water;
a screening device being arranged between the beverage substance and capsule base; and
an annular structure spacing the screening device apart from the capsule base in a central region of the latter to define an interspace between the screening device and the capsule base,
said annular structure defining an outer region and an inner region in the interspace between the screening device and capsule base,
said outer region being connected to the inner region via through-openings.

2. The portion capsule as claimed in claim 1, said beverage substance having ground coffee and the through-openings having a first dimension or a relatively larger second dimension, wherein through-openings having the first dimension are thereby intended for forming a relatively greater amount of crema than through-openings having the second dimension.

3. The portion capsule as claimed in claim 1, said screening device having a supporting structure.

4. The portion capsule as claimed in claim 3, said annular structure being formed integrally with the supporting structure as an injection moulding.

5. The portion capsule as claimed in claim 3, said supporting structure having at least one spacer operable to butt against the capsule base outside the central region of the latter.

6. The portion capsule as claimed in claim 3, said supporting structure being provided with at least one cutout which is covered over by a planar textile fabric.

7. The portion capsule as claimed in claim 3, said screening device having a perforated screen.

8. The portion capsule as claimed in claim 3, said supporting structure having, in the central region, a protuberance which is directed away from the annular structure and is intended for accommodating a spike on a coffee machine coordinated with the portion capsule.

9. The portion capsule as claimed in claim 3, said supporting structure having a reinforcing rim along its periphery.

10. The portion capsule as claimed in claim 1; and a distributor device which is arranged between the capsule cover and the beverage substance.

11. The portion capsule as claimed in claim 10, said distributor device having a plate with through-passages.

12. The portion capsule as claimed in claim 11, said through-passages being configured as radially running slits.

13. The portion capsule as claimed in claim 10, said distributor device having, in the central region, a protuberance which is directed away from the capsule cover and is intended for accommodating a spike on a coffee machine coordinated with the portion capsule.

14. The portion capsule as claimed in claim 1, said capsule base having a predetermined weakened location in its central region.

15. The portion capsule as claimed in claim 14, said predetermined weakened location having a piece of sheet material which is weaker than the capsule base in the vicinity of the piece of sheet material.

16. The portion capsule as claimed in claim 1, said annular structure presenting a height less than 20% of the height of the portion capsule.

17. The portion capsule as claimed in claim 4, said supporting structure having at least one spacer operable to butt against the capsule base outside the central region of the latter.

18. The portion capsule as claimed in claim 4, said supporting structure being provided with at least one cutout which is covered over by a planar textile fabric.

19. The portion capsule as claimed in claim 4, said screening device having a perforated screen.

20. A kit operable to form a portion capsule when assembled, wherein the portion capsule is configured to contain a particulate beverage substance which is extractable from the capsule by water, said portion capsule kit comprising:
a capsule cover and a capsule base operable to cooperatively form a completely enclosed chamber configured to contain the particulate beverage substance;
a screening device in the capsule base; and
an annular structure spacing the screening device apart from the capsule base in a central region of the latter to define an interspace between the screening device and the capsule base,
said annular structure defining an outer region and an inner region in the interspace between the screening device and capsule base,
said outer region being connected to the inner region via through-openings.
